(19) United States
(12) Patent Application Publication
(10) Pub. No.: US 2009/0157968 A1
(43) Pub. Date: Jun. 18, 2009

(54) Cache Memory with Extended Set-associativity of Partner Sets

(75) Inventors: Gordon B. Bell, Madison, WI (US); Anil Krishna, Cary, NC (US); Nicholas D. Lindbert, Rochester, MN (US); Ken V. Vu, Cary, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Research Triangle Park, NC (US)

(21) Appl. No.: 11/954,936

(22) Filed: Dec. 12, 2007

(51) Int. Cl. G06F 12/08

(52) U.S. Cl. 711/128; 711/E12.017

(57) ABSTRACT

A cache memory including a plurality of sets of cache lines, and providing an implementation for increasing the associativity of selected sets of cache lines including the combination of providing a group of parameters for determining the worthiness of a cache line stored in a basic set of cache lines, providing a partner set of cache lines, in the cache memory, associated with the basic set, applying the group of parameters to determine the worthiness level of a cache line in the basic set and responsive to a determination of a worthiness in excess of a predetermined level, for a cache line, storing said worthiness level cache line in said partner set.

### TECHNICAL FIELD

The present invention relates to computer data storage, and more particularly to cache memory subsystems.

### BACKGROUND OF RELATED ART

In order to take advantage of the ever-increasing speed of microprocessors, data storage must either use expensive memory or provide for appropriate cache memory subsystems at appropriate points in the computer network system processing the data. The cache memory is conventionally smaller, faster than the computer system memory and operates at a higher speed than the system memory. The purpose of the cache is to position the information, both instructions and data, that the computer processor is to use next. The information may then be made available to the processor more quickly due to the speed of the cache memory. In most cache systems, when the system processor requests information, the request is first sent to the cache memory. If the cache contains the information, a “hit” signal is issued, and the requested information is sent to the appropriate function under the processor control. If the requested information is not in the cache, a signal indicative of a “miss” is returned to the processor, and the information is then retrieved from the slower system memory.

In the discussion that follows, when the term data is used with respect to caches, it is meant to cover both instructions and data for storage.

A cache is a collection of cache lines: each line includes a tag identifying the line and each line also includes the data content of the line. A successful identification of a tag is a hit. Otherwise, there is a miss. The cache lines are arranged in sets. The address of the data requested includes an index that is used to access the correct set in the cache; the address also includes an address tag that is compared to the cache line tag. If the tags match, there is a hit, and the cache line data is returned to the user. If none of the tags in the set match, the requested line has to be sought from a lower level storage that might be another cache or memory. This is considered a miss. If there is only one cache line in the set, the cache is called direct-mapped. If there is more than one cache line in the set, the cache is called n-way set associative (where n is the number of cache lines in each set). The n locations in each set in an n-way set associative cache are called ways. If the whole cache is a single set and the number of cache lines in the set is equal to the number of ways in the cache, the cache is called fully-associative. When a new cache line is brought in from a lower level storage, it makes space for itself by evicting an already existing line. The candidate for eviction is chosen based upon a selected replacement policy or protocol. Standard eviction protocols are usually variations of a LRU (least recently used) policy, i.e. the cache line that has not been used for the longest time has the highest probability of being evicted.

Direct-mapped or low-associativity caches are subject to interference misses or conflict misses problems. This occurs when accesses to a relatively small number of lines, the number of accesses being larger than the associativity, map to the same set. The access tags differ but there is not enough space in the set to simultaneously keep all of the accesses. If such accesses to these lines are repetitive and in a round-robin fashion, there could be a situation where the accesses always result in a miss. This behavior pattern is known as thrashing. While there may be space in the whole cache to store all of these lines, there is not enough space in any one set to do so.

The problem is further aggravated when multiple hardware threads share a cache. A problem arises when the different threads are running and sharing the same workload, and the associativity in the cache is just enough for one thread, but falls short when multiple threads share the cache. In another situation, the different threads could be running workloads that have very different cache access patterns. One thread might not reuse any of the data it brings into the cache, thus polluting or overloading the cache, while another thread, potentially needing more space in the cache, is not being afforded that space because the first thread's data, although never reused, is occupying valuable space.

Increasing the associativity of the cache has been considered but does not necessarily solve this problem. In fact, increased associativity could increase the problem, particularly in the case of multiple threads sharing a cache. This can be the case because there is no expedient to identify or to weight the value of a line before allocating it space in a cache set. If a thread is streaming through data, it could potentially use up most of the associativity of a set, even if the data is not used. Another drawback of higher associativity leads to a super-linearly higher power requirement in the cache because multiple simultaneous tag comparisons are required to identify a hit or a miss. Such comparisons, if done serially, would significantly increase the access latency of the cache.

Many solutions to improving the utilizing of cache associativity or providing extra associativity, as required, have been tried. However, most of these solution schemes evaluate the worthiness or weight of a cache line before affording it space in the cache. One solution to increase associativity while keeping the power requirement low, the average latency low and the associativity flexible, is to have a small fully-associative buffer in addition to the usual low-associativity cache. This buffer is searched upon the occurrence of a miss in the main cache. It is called a victim buffer or a victim cache. The limitation of this approach is that the victim buffer can handle associativity extension up to a relatively small total amount of extra associativity. Also, there might continue to be associativity lying unused in other parts of the cache.

An idea similar to the victim cache is a micro-cache that provides one or more extra sets in the cache that adaptively associate themselves with and, thus, extend one or more of the existing sets in the cache. The main drawback of such a scheme is that the size of the micro-cache must be limited so as not to increase the overall cache area drastically. Control logic complexity and latency increases are other concerns with the micro-cache scheme. Schemes to reduce the chances of thrashing due to repetitive uniformly spaced addresses have included index-hashing, Column-Associative caches and Skewed-Associative caches. In simple address-hashing schemes, the bits of the address that select the index are hashed and are then used to index into the cache sets. The disadvantage with this technique is that the hashing is static and can still suffer from the same problems described above. Hash-Rehash caches and Column-Associative caches use two hash functions to hash the index-bits in the address to evaluate the index. The first hash function is applied first, and upon a miss, the second hash function is applied. The existing storage in the cache is used to place a conflicting address. Column-Associative caches extend Hash-Rehash caches with a few relatively minor optimizations. The drawback of these schemes is that they have been described for direct-mapped caches only. The Skewed-Associative cache reduces the chance of set interference by using different hashes for indexing into different ways of a cache. These hashes are applied simultaneously rather than serially as in the earlier schemes. Thus, lines that would originally all map to the same set typically get mapped to different sets. The disadvantage of this scheme is that extra mapping hardware is required.

There has also been proposed a (Most Recently Used) MRU bit array that eliminates the need for data swapping between the primary and secondary locations for a line in a multiple-access cache. The MRU bit array is accessed beforehand to determine which location should be probed first. LRU-Based Column-Associative Caches extend the Column-Associative Cache to more than two (2) locations for a line, but require even longer sequential searches through the caches. If the primary location results in a miss, the secondary location is searched. If the secondary location results in a miss, a tertiary location is searched, etc. The disadvantage of this scheme is the long latency to access the cache and the overall performance gain this scheme can give, given the additional hardware overhead required to implement this scheme.

The problem of sharing the storage in a cache is optimally even more important when there are multiple threads that share the cache. This problem has only recently come into prominence with the design of semiconductor chips with multiple processing units. Such multi-core (multi-CPU) chips typically let caches be shared by more than one thread. Often, for Level 2 caches, the number of threads sharing the cache is sixteen (16) or more. Under such circumstances, it is highly likely that a few “bad” threads could hijack the space on the cache by being aggressive in accessing the cache, while not being very efficient in using the data fetched. An example of such a thread might be one that is running a streaming benchmark. The workload accesses a lot of data; regularly spaced, randomly spaced or a mixture of the two, and brings accessed data into the cache, but only rarely reuses the data in the cache. In such a scenario, all the other threads that bring in less data, but which would have actually reused the data, might suffer at the expense of the few “bad” threads.

The v-way cache addresses a problem similar to the problem that will hereinafter be addressed in the present invention by using a tag-array independent from the data-array. The tag-array is organized as a set-associative array, whereas the data array is organized as a direct-mapped array. The tag-array has forward pointers to the entry in the data-array containing the data corresponding to the tag. The data can be anywhere in the data-array, and not necessarily tied one-to-one to the tag-array entry. Also, the tag-array trades utilization for flexibility. It is typically only half or less-than-half full. However, a given set can grow in associativity, if necessary, at the expense of another set or sets in the cache, shrinking in associativity. The benefits of this scheme are reduction in conflict misses due to higher associativity and global replacement of data due to keeping the data-array separate. The disadvantages are that every access to data requires an initial access to the tag-array, followed by another sequential access to the data-array depending on the forward pointer. This detached tag-array and data-array design, therefore, leads to a longer best-case latency. Similarly, on a replacement, after a data line eviction in the data-array, the reverse pointer is followed to the tag-array entry to invalidate it.

Several other solutions to the problem of efficiently and fairly allocating storage in a cache shared by multiple threads (fair partitioning) have been proposed. Many of these schemes use way-partitioning that reallocate the existing ways in a set among threads sharing the cache. The drawback of these schemes is that the ideas are not scalable, as the number of threads sharing a cache grows because the set-associativity of the cache could be smaller than the number of threads. Partitioning the ways among the threads works well when there are fewer threads than ways, thereby allowing at least one way in a set to be allocated to each thread.

In addition, the Utility-based Cache Partitioning relies on hardware structures called UMONs (Utility Monitors) that count the “utility” characteristics of each thread for each cache set (or, over all cache sets) over a large number of clocks (5 million) and adjusts the partition every so often. This might be too large of a granularity for the system to be reactive enough.

Accordingly, there is a need for an efficient way to share cache associativity in a processor system without relying on extraneous storage (like a victim-cache or a micro-cache), without being limited to direct-mapped caches (like the hash-rehash or column-associative caches), without relying on way-partitioning (that works when there are fewer threads than associativity) and without reacting slowly to the dynamics of cache utilization, especially when a large number of threads share the cache (like in Utility Based Computing),

### SUMMARY OF THE INVENTION

In its broadest aspects, the present invention provides for the improved utilization of cache storage by determining which lines of data are worthy of the cache space, i.e. have sufficient value to be provided cache space and then judiciously utilizing space in a cache set different from the set that the cache line indexes into.

More particularly, the present invention relates to a cache memory including a plurality of sets of cache lines, and provides an implementation for increasing the associativity of selected sets of cache lines including the combination of providing a group of parameters for determining the worthiness of a cache line stored in a basic set of cache lines, providing partner sets of cache lines, in the cache memory, associated with the basic set, applying the group of parameters to determine the worthiness level of a cache line in the basic set and responsive to a determination of a worthiness in excess of a predetermined level, for a cache line, storing said worthiness level cache line in said partner set.

In accordance with one operative aspect of the invention, the cache memory is an n-way set associative cache and the access input to the cache is greater than n input threads. In providing for the partnering, there is provided an implementation enabling said basic set to borrow ways from said partner set, wherein the number of ways in the set of cache lines is increased. A function is provided associated with said basic cache for indicating the cache lines stored in said partner cache.

For best results, the means for determining the worthiness level and the means for storing cache lines in the partner set are dynamically operative while data lines are being input into the cache memory.

In accordance with another aspect of the invention, an implementation is provided for evicting selected cache lines from said basic set in order to prevent exceeding the capacity of said basic set, wherein the means for determining said worthiness level determine the worthiness of an evicted cache line. The worthiness of a cache line may be determined by the reuse potential of the cache line, and the reuse of an evicted cache line may have already been so tracked prior to eviction.

Apparatus for applying the cache line set partnering of the present invention in cache memory system may be embodied in the combination of a data array for storing said basic and partner sets of cache lines, a tag array for storing tags to said respective cache lines and a ghost tag array for storing tags for respectively indicating the cache lines stored in said partner cache.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic illustration of a conventional 4-way set associative cache in a cache memory;

FIG. 2 is a simplified diagrammatic 4-way set associative cache of FIG. 1 illustrating how the cache may be accessed by many cores, i.e. multi-CPUs that provide a number of access threads exceeding the number of ways (4);

FIG. 3 is the conventional 4-way set associative cache shown in FIG. 1 modified to include a ghost tag array used in implementing the present invention;

FIG. 4 is a diagrammatic illustration in accordance with FIG. 3 showing how the ghost tag array functions in implementing the present invention;

FIG. 5 is a flowchart illustrating how the steps embodying a primary aspect of the present invention is carried out;

FIG. 6 is a flowchart illustrating how a determination is made as to whether to retain a candidate cache line for eviction in a cache partnership association according to the present invention; and

FIG. 7 is a flowchart of an algorithm to determine the replacement of cache lines in the partner cache set when the latest cache line achieves the worthiness level required for storage in the partner cache.

### DETAILED DESCRIPTION OF THE PREFERRED EMBODIMENT

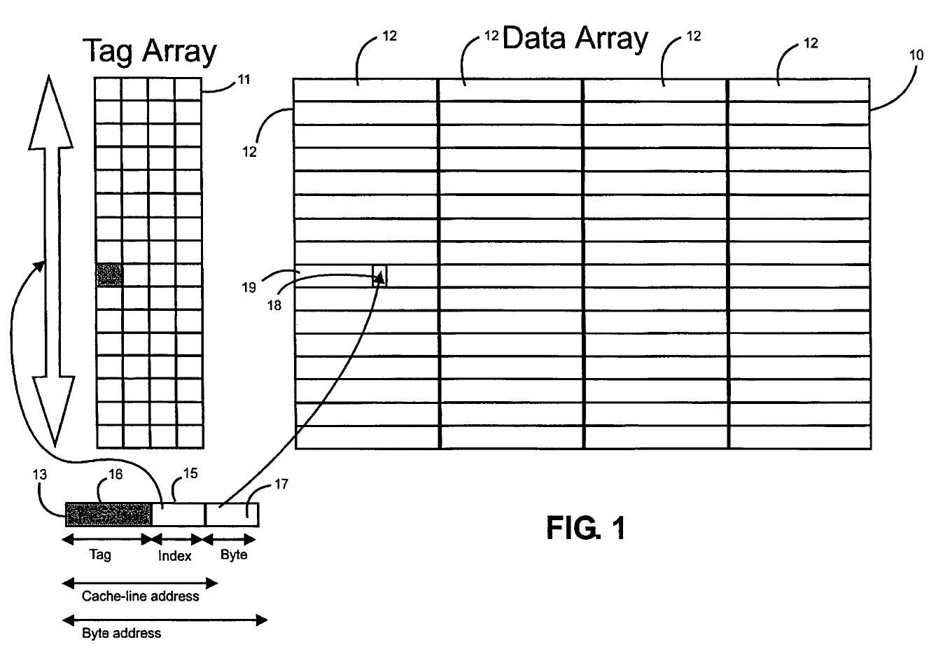

Conventionally, processors supporting memory caches have two main storage arrays (FIG. 1)—a Tag Array 11 and a Data Array 10. The structure of a 4-way set associative cache is shown in FIG. 1. The Data Array 10 of the cache holds cache lines 12 that are, in a typical desktop or server processor, 16 bytes to 128 bytes in size and are accessed by an address. The Tag Array holds the “tags” 14 that are a part of the address 13 used to identify the cache line. The bits in the cache lines address 13 are broken into bit-fields and used to locate a cache line. The bits used to find the appropriate set in the cache are called the “index” bits 15. The set may have more than one cache-line in it.

In the illustration shown in FIG. 1, the cache memory is a 4-way cache, i.e. there are four (4) cache lines in a set and each line has a corresponding tag 14. The cache line address 13 has a tag 16 that is compared to a corresponding tag 14 in the tag array 11, and if a match is found, then the appropriate cache line 12 in the data array 10 is retrieved. This is a cache “hit”. If none of the tags in the indexed set in the Tag Array match the tag for the cache line being searched, it is considered a cache “miss” and appropriate action is taken to fetch the line from a lower level storage. Once a cache line is identified, it is returned to the requester, which could be a processor or another cache. If necessary, part 17 of the cache line address, typically the least significant bits, could be used to identify the exact byte 18 in a cache line 19 that was requested.

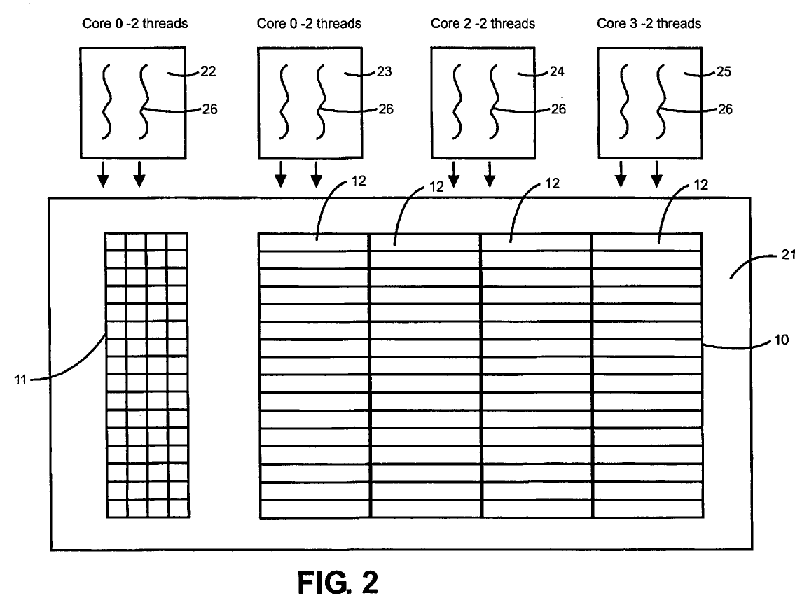

When a cache is shared by many cores, e.g. multi-CPU semiconductor chips that will have many more threads (simultaneously running execution sequences that may each access the cache), the cache appears as a uniform resource to all of the threads. However, the thread that uses the space in the cache most aggressively tends to use up more space in the cache. Aggressively making requests to the cache and thereby using more of the cache does not necessarily imply that the thread is using the cache efficiently. The overall throughput, performance or both may suffer because the other threads could be starved for cache space. FIG. 2 shows an overall 4-way set associative memory cache 21, like that of FIG. 1, shared by four (4) cores 22-25 (CPUs) running two (2) threads 26 (paths) each.

To more efficiently use the cache space, whether a single thread or multiple threads use it, it is important to recognize that cache lines are making effective use of the cache space and which lines are not. A cache line that is used one or more times after the first access brings it in might be considered one that uses the cache space more effectively than a cache line that, after the initial access, is never used again before it is evicted. Several schemes to measure reuse effectiveness use counters that count how often a line was accessed after being brought into the cache.

It should be noted that reuse potential is not the only attribute that could determine worthiness. For example, the threads providing cache lines could be given weights or priorities that could be used to determine the worthiness of cache lines from such threads.

The present invention prefers an embodiment, to be hereinafter described in detail, that uses an extra Tag Array that may be referred to as a “Ghost Tag Array” or “Shadow Tag Array”. A purpose of this Ghost Tag Array is to retain information about cache lines that are no longer in the main (basic) data array.

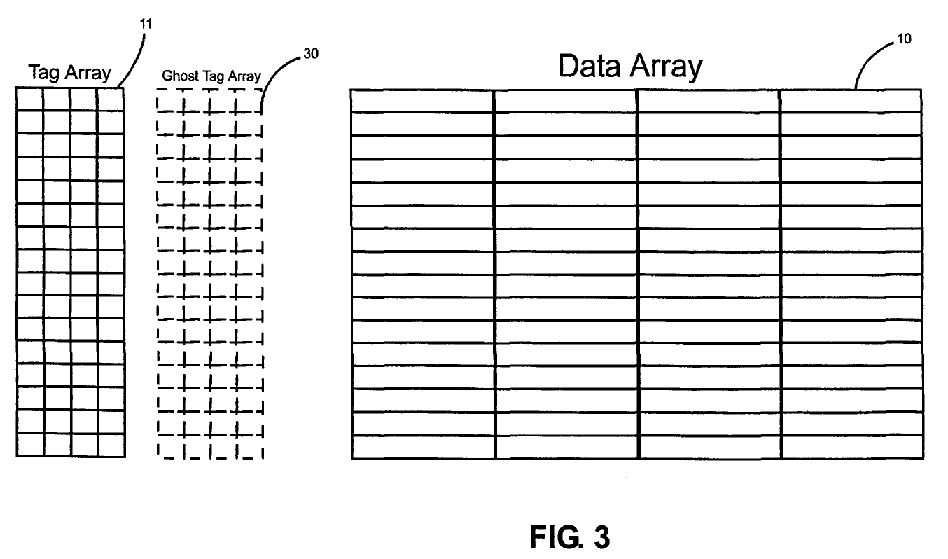

This implementation is shown in FIG. 3, which is the memory array of FIG. 1 with the supplementary Ghost Tag Array 30 that does not have any data array corresponding to it. It is relatively small in hardware overhead because it only keeps part of the information the primary Tag Array would keep per cache line. It only needs to store the actual tag portion of a cache line and a few more bits to keep track of “worthiness”, which will be hereinafter described. The purpose of the Ghost Tag Array is to hold the tag information for cache lines evicted from the main Tag Array. Such stored tags for lines evicted from any set in the relatively recent past could indicate a line that could have used extra associativity if the cache set could have provided it. Counter-based schemes, typically, measure the reuse of cache lines that are in the Tag and Data Arrays. With the Ghost Tag Array we can also measure the reuse potential of a cache line that is no longer in the main Tag and Data Arrays. The partner set implementation of the present invention may use any appropriate scheme to determine the “worthiness” of a cache line, i.e. to determine whether a line could use extra associativity if it were provided to it as a means of staying in the cache.

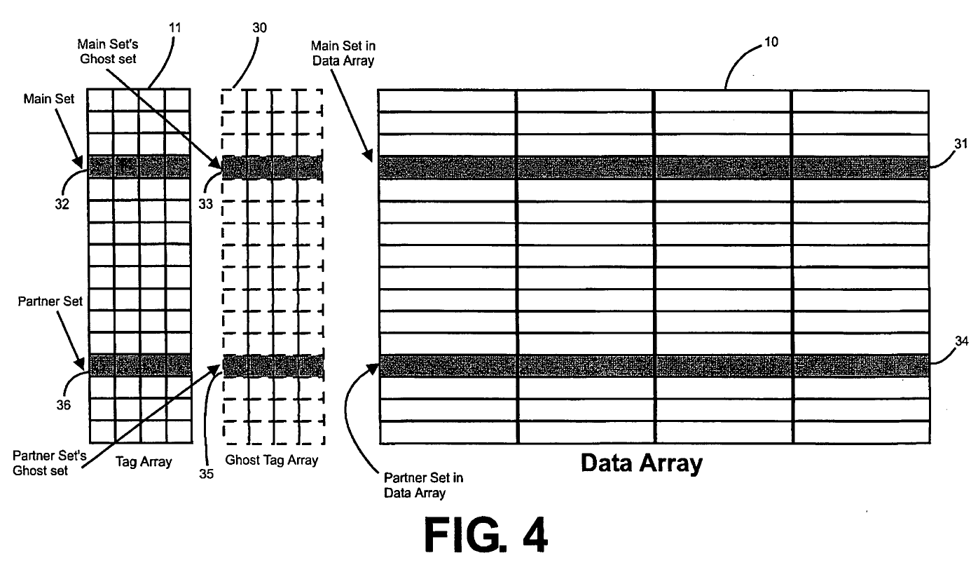

FIG. 4 shows the operation of the various components of the memory cache in accordance with the present invention. The process involves: 1. Identifying a cache line that is “worthy” of being given preference, both when evaluating offering extra associativity and during replacement or eviction; and 2, extending a cache line set's associativity by “borrowing ways from another set or sets in the cache. FIG. 4 shows a “Main Set”, i.e. the basic sets extending across the Tag Array 11 (tag set 32), the Ghost Tag Array 30 (tag set 33) and the Data Array 10 (line set 31). These are “main” or basic only in the sense that the line set 31 represents a set that is looking to extend its associativity at a given point in time. Otherwise, basic line set 31 is not different from any other set. FIG. 4 also shows a Partner Set 34 of a corresponding four (4) cache lines extending across the Data Array 10, the Ghost Tag Array 30 (tag line 35) and the Tag Array 11 (tag line 36). The partner set implementation involves selecting a set of cache lines from all the sets in the memory cache that can be used by the basic or Main Set for the purpose of borrowing associativity. In the preferred embodiment, this partner set 34 is identified by a simple rehash of the index bits that index into the Main (basic) Set 31. We will refer to the index bits that index into the Main Set, the primary index, and refer to the index that identifies the Partner Set, the secondary index. A simple example of a rehash is one that flips the most significant bit of the primary index to generate the secondary index. For example, assume a cache with 1024 cache line sets. Then, sets 0 and 512 could be partners; and sets 1 and 513 would be partners; etc. Another scheme could use a simple bit flip of all the bits that identify the basic set so as to identify the partner set to the basic set. In this case, in a cache with 1024 sets, sets 0 and 1023, 1 and 1022, etc. will be partners.

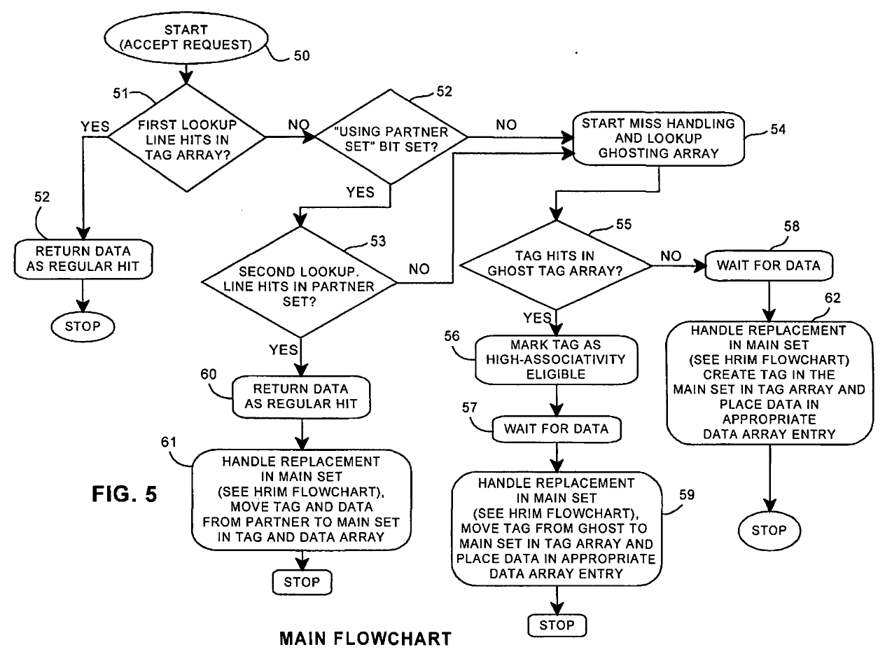

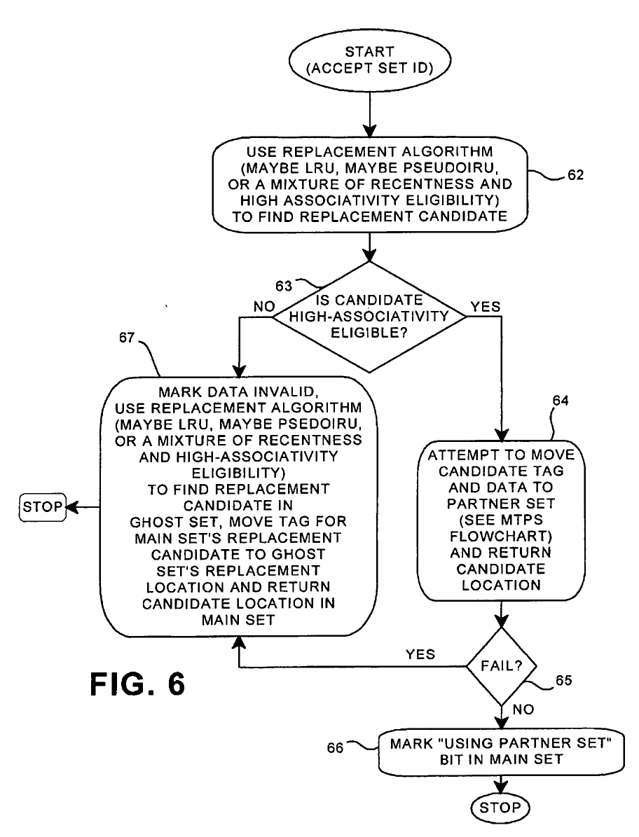

Now, with respect to FIG. 5, a generalized overall description of the flow of the present invention will be described in the form of the flowchart. Upon receiving a data access request step 50, the memory cache controller calculates the primary index from the request's address, as previously described with respect to FIG. 1. Using the primary index, the Tag Array is looked up and after tag comparison a hit or miss is identified, decision step 51. If Yes, a hit, the request is handled as a regular hit, step 52, so that the data is returned to the requester in case of a load and/or data is accepted into the Data Array in case of a store. If the decision is No, a miss, all the other sets that could be holding data corresponding to the main (basic) set would conventionally be looked up. However, in our illustrative implementation, there is only a single partner set per main (basic) set. There is maintained, per set, a bit in the tag array that indicates if the partner set corresponding to this basic set should be looked at. For example, if no space in the partner set is currently borrowed, there is no need to look up the partner set. Since this access to the partner set is in the critical access path, it is desirable to avoid the extra lookup. If the bit in the main (basic) set that identifies if any space in the Partner Set is in use (“using partner set” bit), step 52, is OFF (No), or, if the bit is ON (Yes) and a lookup of the Partner Set, step 53, results in No (a miss), the miss is conventionally handled by requesting the lower level storage (not shown). Simultaneously, the Ghost Tag Array corresponding to the Main Set is looked up, step 54. A determination is made, step 55, as to whether the tag hits in the Ghost Tag Array, indicates that the requested line was in the cache in the past and could have resulted in a hit had there been sufficient space in the cache to retain the line in the cache. This will result in step 55 Yes, and the line is recognized as “worthy” of extra associativity and the tag is marked as “high-associativity eligible”, or simply, “worthy”, step 56. At that point, and also in case the lookup in the Ghost Tag Array set corresponding to the Main Set results in a miss, step 55, No, the cache waits for miss data to come back from the lower level storage, steps 57 and 58, at which point the Handle Replacement In Main-Set (HRIM) flowchart is executed, as will be subsequently described with respect to FIG. 6, followed by installing the newly brought in line in the Main Set's Tag Array and Data Array. In case there was a hit in the Ghost Tag Array, step 55, Yes, then step 59, the tag is removed from the Ghost Tag Array since it has found a place in the main array, and the HRIM flowchart is executed. In case there was a miss in the Ghost Tag Array, step 55, No, then step 62, the tag is created in the Ghost Tag Array and corresponding data placed in the main (basic) array.

As ancillary considerations, in case of a store-back cache (also known as write-back cache), the miss handling described above applies to both load and store misses (in most cases). In case of a store-through cache (also known as a write-through cache), the miss handling described above applies only to load misses since store-misses do not bring any data into the cache.

Continuing with respect to FIG. 5, if the bit in the Main Set that identifies “using partner set” is ON, step 52, Yes, and lookup of the Partner Set results in a hit, step 53, Yes, the data is returned to the requester in case of a load and data is accepted into the Data Array in case of a store, step 60. Then, step 61, the HRIM flowchart is executed (as will be hereinafter described with respect to FIG. 6) and the tag and data from the Partner Set's Tag Array and Data Array are moved into the Main Set in the cache. The rationale for this data movement is that the next time this data is accessed it is a hit in the Main Set itself rather than requiring a second lookup into the Partner Set. This data and tag movement can be handled in the background and does not affect the critical path of returning data to the requester. If this is the last line belonging to the Main Set that was in the Partner Set, then the bit in the Main Set identifying “using partner set” can be cleared to avoid unnecessary lookups into the Partner Set in the future. It is easy to imagine a scheme to keep track of whether the line is the last line belonging to the Main Set in a Partner Set. The “using partner set” bit could be extended to “number of lines in partner set”. A count of 0 indicates that the Partner Set is not in use by the Main Set. A count of 1 indicates, in the situation described above, that the cache line in the Partner Set that belongs to the Main Set is the last such cache line, and if it is ever moved back to the Main Set, the “number of lines in partner set” should, upon decrementing, become 0, and, thus, indicate that the Partner Set is no longer being used by the cache lines in the Main Set.

As has been previously mentioned, the means for determining the worthiness level and the means for storing cache lines in the partner set are, preferably, dynamically operative while data lines are being input into the cache memory. In such a dynamic environment, an implementation is provided for evicting selected cache lines from said basic set in order to prevent exceeding the capacity of said basic set, wherein the means for determining said worthiness level determine the worthiness of an evicted cache line. The worthiness of a cache line may be determined by the reuse potential of the cache line and the reuse of an evicted cache line may have already been so tracked prior to eviction. An embodiment of this will be described with respect to the Handle Replacement In Main-Set (HRIM) flowchart of FIG. 6. A replacement candidate, i.e. candidate for eviction is identified in the Main (basic) Set, step 62. The replacement policy could be any of the usual replacement policies used in caches (LRU, pseudoLRU, FIFO, Random, etc.) or, as a proposed optimization, could utilize the “worthy” bit information to reduce the probability of replacing cache-lines that have proven to be reused. Developers of eviction routines should provide routines to ensuring that lines that have been recently brought in and have not had a chance to prove their “worth” should not be overly penalized, and similarly, lines that proven their worth in the past but have not been used in a long time are not retained in the cache at the expense of other lines.

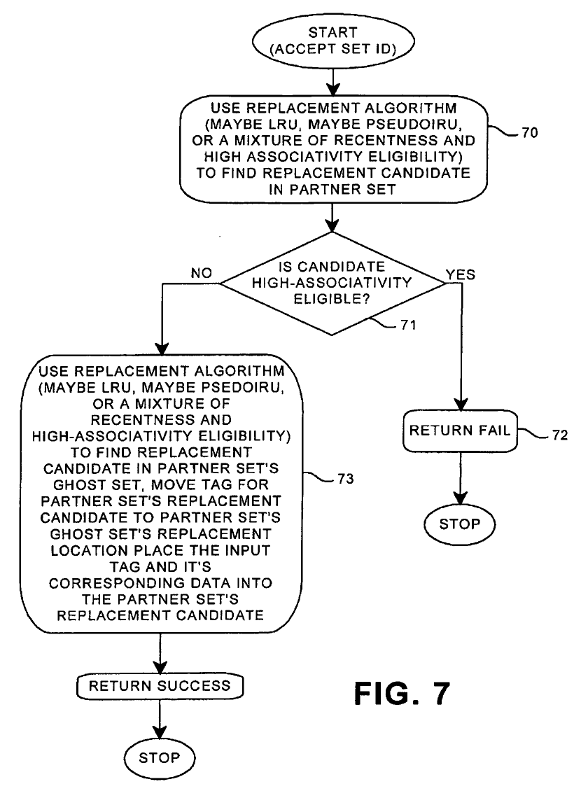

If the replacement candidate in the Main Set is marked “worthy” or high associativity eligible, step 63, Yes, then additional associativity must be borrowed in the cache so as not to lose the data from the Data Array. The tag and data corresponding to this replacement candidate are attempted to be moved to the Partner Set, step 64. An example of such a move to partner procedure will be described with respect to the Move To Partner Set (MTPS) flowchart of FIG. 7. If the attempt to save the line in the Partner Set succeeds, then, step 66, we have made space in the Main Set's Tag and Data Array. The “using partner set” bit in the Main Set is marked and this step is complete. If the attempt to save the line in the Partner Set fails, a No from “Fail?” decision, step 65, or, if the replacement candidate in the Main Set is not marked “worthy”, step 63, No, its tag is then moved to the corresponding Ghost Set, step 67. To make space for this tag in the Ghost Set, an algorithm, similar to the replacement algorithm, herein identifies a candidate to be evicted from the Ghost Set. The Data corresponding to the line evicted from the Main Set is removed from (marked invalid in) the Data Array. The Tag and Data Array locations, thus freed up in the Main Set, are populated with the miss data when it returns from lower level storage.

When a cache data line is found to be sufficiently worthy to be moved to the partner set, an additional determination must be made as to space available in the partner set.

A flowchart, MTPS flowchart (FIG. 7) will now be described. The cache line that is identified to be moved to the Partner Set needs space in the Partner Set. To make space in the Partner Set, a replacement algorithm is used to identify a replacement candidate in the Partner Set, step 70. It is suggested that the replacement algorithm be optimized to take into consideration the “worthy” attribute of a line and be further optimized to distinguish lines that originally belong to the Partner Set and lines that originally belong to the Main Set but are borrowing space in the Partner Set. If the, thus, recognized candidate is marked as “worthy”, Step 71, Yes, the attempt to make space in the Partner Set is deemed a failure, step 72, and that is returned, i.e. communicated to, the Cache Controller. How the cache controller handles such a reported failure by the MTPS algorithm has been described in FIG. 6. If the replacement candidate identified in the Partner Set is not marked “worthy”, step 71, No, it is moved to the Partner Set's Ghost Set, step 73. A replacement algorithm similar to the one described earlier in the description of the Main flowchart makes space in the Ghost Set. The tag and data corresponding to the line that is attempting to move into the Partner Set are appropriately installed.

Since the steps laid out in the HRIM flowchart, FIG. 6, and the MTPS flowchart, FIG. 7, occur in parallel with the fetching of the miss data, there is no latency overhead introduced by this process. It may be argued that the hit latency is compared longer to a typical cache when there is a miss to the Main Set and a hit to the Partner Set, since that constitutes a second lookup. It is believed that a hit on the second lookup is a better option as compared to the miss on the first lookup with no opportunity for a second lookup. Special care must be taken to make sure that the Main Set always has the most “worthy” lines that access that set, and the Partner Set acts to catch a few that spill over from the Main Set on a best-effort basis.

Although certain preferred embodiments have been shown and described, it will be understood that many changes and modifications may be made therein without departing from the scope and intent of the appended claims.

What is claimed is:

1. In a cache memory including a plurality of sets of cache lines, a system for increasing the associativity of selected sets of cache lines comprising:
means for providing a group of parameters for determining the worthiness of a cache line stored in a basic set of cache lines;
means for providing at least one partner set of cache lines, in said cache memory, associated with said basic set;
means for applying said group of parameters to determine the worthiness level of a cache line in said basic set;
means, responsive to a determination of a worthiness in excess of a predetermined level, for a cache line for storing said worthiness level cache line in said partner set.

2. The cache memory system of claim 1, wherein:
said cache memory is a n-way set associative cache; and
the access input to said cache is greater than n input threads.

3. The cache memory system of claim 1, wherein said means for providing said partner set of cache lines includes means enabling said basic set to borrow ways from said partner set, wherein the number of ways in the set of cache lines is increased.

4. The cache memory system of claim 3 further including means associated with said basic cache for indicating the cache lines stored in said partner cache.

5. The cache memory system of claim 1, wherein:
said means for determining the worthiness level, and said means for storing cache lines in said partner set are dynamically operative while data lines are being input into said cache.

6. The cache memory system of claim 5:
further including means for evicting selected cache lines from said basic set in order to prevent exceeding the capacity of said basic set, wherein
said means for determining said worthiness level determine the worthiness of an evicted cache line.

7. The cache memory system of claim 6, wherein the worthiness of a cache line is determined by the reuse potential of the cache line.

8. The cache memory system of claim 7 further including means for tracking the reuse of the evicted cache line prior to eviction.

9. The cache memory system of claim 4 including:
a data array for storing said basic and partner sets of cache lines;
a tag array for storing tags to said respective cache lines; and
a ghost tag array for storing tags for respectively indicating the cache lines stored in said partner cache.

10. In a cache memory including a plurality of sets of cache lines, a method for increasing the associativity of selected sets of cache lines comprising:
providing a group of parameters for determining the worthiness of a cache line stored in a basic set of cache lines;
providing at least one partner set of cache lines, in said cache memory, associated with said basic set;
applying said group of parameters to determine the worthiness level of a cache line in said basic set; and
storing a worthiness level cache line in said partner set responsive to a determination of worthiness in excess of a predetermined level, for said cache line.

11. The method of claim 10, wherein:
said cache memory is a n-way set associative cache; and
the access input to said cache is greater than n input threads.

12. The method of claim 10, wherein said step of providing said partner set of cache lines includes enabling said basic set to borrow ways from said partner set, wherein the number of ways in the set of cache lines is increased.

13. The method of claim 10, wherein:
said step of determining the worthiness level, and said step of storing cache lines in said partner set are carried out dynamically while data lines are being input into said cache.

14. The method of claim 13:
further including the step of evicting selected cache lines from said basic set in order to prevent exceeding the capacity of said basic set, wherein
said step of determining said worthiness level determines the worthiness of an evicted cache line.

15. The method of claim 14, wherein the worthiness of a cache line is determined by the reuse potential of the cache line.

16. The method of claim 15 further including the step of tracking the reuse of the evicted cache line prior to eviction.

17. A computer program implementation comprising a computer usable medium having stored thereon a computer readable program for increasing the associativity of selected sets of cache lines in a cache memory including a plurality of sets of cache lines, wherein the computer readable program when executed on a computer causes the computer to:
provide a group of parameters for determining the worthiness of a cache line stored in a basic set of cache lines;
provide at least one partner set of cache lines, in said cache memory, associated with said basic set;
apply said group of parameters to determine the worthiness level of a cache line in said basic set;
store a worthiness level cache line in said partner set responsive to a determination of a worthiness in excess of a predetermined level, for said cache line.

18. The computer program of claim 17, wherein:
said cache memory is a n-way set associative cache; and
the access input to said cache is greater than n input threads.

19. The computer program of claim 18, wherein said computer program causes said computer to dynamically determine the worthiness level, and to dynamically store cache lines in said partner set.

20. The computer program of claim 19, wherein said computer program causes said computer to evict selected cache lines from said basic set in order to prevent exceeding the capacity of said basic set and to determine said worthiness level of an evicted cache line.

21. The computer program of claim 20, wherein the worthiness of a cache line is determined by the reuse potential of the cache line.
